(19) United States
(12) Patent Application Publication
(10) Pub. No.: US 2025/0301541 A1
(43) Pub. Date: Sep. 25, 2025

(54) Induction Hob for Easy Storage

(71) Applicant: Guangdong Willing Technology Corporation, Huizhou (CN)

(72) Inventors: Jingnong Ye, Huizhou (CN); Shifa Luo, Huizhou (CN); Jiulong Wang, Huizhou (CN)

(21) Appl. No.: 18/749,594

(22) Filed: Jun. 20, 2024

(30) Foreign Application Priority Data
Mar. 22, 2024 (CN) 202420573556.9

(51) Int. Cl. H05B 6/12; H05B 1/02

(52) U.S. Cl. CPC H05B 6/1245; H05B 1/0266

(57) ABSTRACT

Disclosed in the present disclosure is an induction hob for easy storage, including a first hob and a second hob, in which the first hob and the second hob are configured with a first cooking position and a second cooking position respectively, the first cooking position and the second cooking position are capable of performing cooking simultaneously, a rotation connecting mechanism is provided between the first hob and the second hob, the first cooking position and/or the second cooking position are/is able to rotate around the rotation connecting mechanism until the a front panel of the first hob is facing a front panel of the second hob or a back panel of the first hob is facing a back panel of the second hob. The structure of the present disclosure is reasonably designed, not only increasing the cooking space, but also convenient for storage.

### CROSS REFERENCE TO RELATED APPLICATIONS

The present application claims the benefit of Chinese Patent Application No. 202420573556.9 filed on Mar. 22, 2024, the contents of which are incorporated herein by reference in their entirety.

### FIELD

The present disclosure relates to the technical field of induction hobs and, particularly, to an induction hob for easy storage.

### BACKGROUND

Induction hobs are common household appliances in daily life. An alternating current may be introduced into the electromagnetic coil when in use, and an alternating magnetic field will be generated around the coil, and most of the magnetic lines of the alternating magnetic field pass through the metallic pan, generating a large number of eddy currents in the bottom of the pan, thereby generating the heat required for cooking.

Existing induction hobs generally contain only one hob and one cooking position, which is unable to satisfy the user's need to cook with multiple cookers at the same time. Increasing the number of hobs directly to two leads to the induction hob being too long, which renders it unable to be stored well.

### SUMMARY

An objective of the present disclosure is to provide an induction hob for easy storage to solve the technical problems that the existing induction hobs generally contain only one hob and one cooking position, which is unable to satisfy the user's need to cook with multiple cookware at the same time, and also solve that increasing the number of hobs directly to two leads to the induction hob being too long, which renders it unable to be stored well.

In order to achieve the purpose mentioned above, provided by the technical solution of the present disclosure is an induction hob for easy storage, including a first hob and a second hob, in which the first hob and the second hob are configured with a first cooking position and a second cooking position respectively, the first cooking position and the second cooking position are capable of performing cooking simultaneously, a rotation connecting mechanism is provided between the first hob and the second hob, the first cooking position and/or the second cooking position are/is able to rotate around the rotation connecting mechanism until the a front panel of the first hob is facing a front panel of the second hob or a back panel of the first hob is facing a back panel of the second hob.

Further, the rotation connecting mechanism comprises a plurality of connecting shafts arranged in parallel, both ends of the connecting shaft are extended to the first hob and the second hob respectively, both ends of the connecting shaft are connected to rotating shafts arranged in parallel to each other respectively, an end of the rotating shaft is fixedly connected to an outer peripheral wall of the connecting shaft, an opposite end of the rotating shaft is extended outwardly in a radial direction of the connecting shaft, the first hob and the second hob are rotatably connected to the rotating shafts on both ends of the connecting shaft respectively, and the first hob and the second hob are rotated about the rotating shaft proximal thereto respectively.

Further, both ends of the connecting shaft are provided with two rotating shafts respectively, two rotating shafts positioned on a same end of the connecting shaft are provided coaxially and are both connected to the first hob or the second hob.

Further, at least one of the connecting shafts is provided with a connecting channel in communication with both ends of the connecting shaft, wires are threaded through the connecting channel, both ends of the wires are extended to the first hob and the second hob and power the first cooking position and the second cooking position, one of the first hob and the second hob is provided with a power line, the power line is electrically connected to an end of the wires proximal thereto, and the connecting channel wraps at least partially around the wires.

Further, the connecting shaft is in a flat tubular shape, the connecting shaft is provided with an upper surface, a lower surface, and two lateral surfaces in a height direction of the induction hob, and both the upper surface and the lower surface are planar and connected to both lateral surfaces in a smooth transition.

Further, a side of the first hob proximal to the second hob is provided with a first connecting part, a side of the second hob proximal to the first hob is provided with a second connecting part, the first connecting part is provided opposite to the second connecting part, a quantity of the first connecting part and that of the second connecting part corresponds to that of the connecting shafts respectively, the rotating shafts respectively positioned on both ends of the connecting shaft are rotatably connected to the first connecting part and the second connecting part respectively, and the first connecting part and the second connecting part are rotated about the rotating shaft proximal thereto.

Further, the first connecting part is provided with a first avoidance opening, the second connecting part is provided with a second avoidance opening, both ends of the connecting shaft are placed into the first avoidance opening and the second avoidance opening respectively, the first connecting part is provided with a first connecting groove, the second connecting part is provided with a second connecting groove, the rotating shafts positioned on both ends of the connecting shaft are placed into the first connecting groove and the second connecting groove, and the first connecting groove and the second connecting groove are rotated about the rotating shaft proximal thereto.

Further, the first connecting part comprises a first half block and a second half block opposite to each other, both the first half block and the second half block are provided in a height direction of the induction hob, both the first half block and the second half block are provided with first semi-circular grooves opposite to each other, radii of two first semi-circular grooves correspond to each other, and depths of two first semi-circular grooves correspond to each other;
the first avoidance opening is formed by opposite abutting of the first half block and the second half block, and the first connecting groove is formed by opposite abutting of the two first semi-circular grooves;
the second connecting part comprises a third half block and a fourth half block provided opposite to each other, the third half block and the fourth half block are provided in a height direction of the induction hob, both the third half block and the fourth half block are provided with second semi-circular grooves opposite to each other, radii of two second semi-circular grooves correspond to each other, and depths of two second semi-circular grooves correspond to each other; and
the second avoidance opening is formed by opposite abutting of the third half block and the fourth half block, and the second connecting groove is formed by opposite abutting of the two second semi-circular grooves.

Further, in a height direction of the induction hob, the first hob comprises a first bottom housing, a first top housing, and a first glass front panel provided sequentially from bottom to top, a first electromagnetic coil is provided between the first bottom housing and the first top housing, the first cooking position is provided on the first glass front panel, the first electromagnetic coil is positioned right below the first cooking position, the second hob comprises a second bottom housing, a second top housing, and a second glass front panel provided sequentially from bottom to top, a second electromagnetic coil is provided between the second bottom housing and the second top housing, the second cooking position is provided on the second glass front panel, and the second electromagnetic coil is positioned right below the second cooking position; and
the first glass front panel is formed as the front panel of the first hob, the first bottom housing is formed as the back panel of the first hob, the second glass front panel is formed as the front panel of the second hob, and the second bottom housing is formed as the back panel of the second hob.

Further, the first bottom housing is detachably connected to the first top housing, the first half block is fixed provided on the first bottom housing, the second half block is fixed provided on the first top housing, the first avoidance opening and the first connecting groove are formed by opposite abutting of the first bottom housing and the first top housing, the second bottom housing is detachably connected to the second top housing, the third half block is fixed provided on the second bottom housing, the fourth half block is fixed provided on the second top housing, and the second avoidance opening and the second connecting groove are formed by opposite abutting of the second bottom housing and the second top housing.

In summary, the technical solutions of the present disclosure provide the beneficial effects as follows:

By including the first hob and the second hob, the first hob and the second hob are configured with the first cooking position and the second cooking position respectively, so that the first cooking position and the second cooking position may be cooked simultaneously, thereby allowing the present induction hob to achieve simultaneous cooking of two cookers to satisfy the user's cooking needs.

By providing a rotation connecting mechanism between the first hob and the second hob, the first hob and the second hob rotate around the rotation connecting mechanism, so that the first hob and the second hob are capable of being folded together. When it is desired to be stored after cooking, the first hob may be rotated around the rotation connecting mechanism to the opposite position of the second hob, or the second hob may be rotated around the rotation connecting mechanism to the opposite position of the first hob, so as to allow the first hob and the second hob to be folded together, which shortens the length of the induction hob and very convenient to be stored.

### BRIEF DESCRIPTION OF THE DRAWINGS

FIG. 1 is a schematic perspective structural diagram in a bottom view of the present invention;

FIG. 2 is a schematic perspective structural diagram in a top view of the present invention;

FIG. 3 is a schematic perspective structural diagram in a top view of the first glass front panel and the second glass front panel in the present invention;

FIG. 4 is a schematic perspective structural diagram in a top view of the present invention removing the first glass front panel and the second glass front panel;

FIG. 5 is a schematic perspective structural diagram in a top view of the first top housing and the second top housing in the present invention;

FIG. 6 is a schematic perspective structural diagram in a bottom view of the first top housing and the second top housing in the present invention;

FIG. 7 is a schematic perspective structural diagram in a top view of the present invention removing the first top housing and the second top housing;

FIG. 8 is a schematic perspective structural diagram in a top view of the first bottom housing and the second bottom housing in the present invention;

FIG. 9 is a schematic perspective structural diagram in a top view of the rotation connecting mechanism in the present invention;

FIG. 10 is a schematic perspective structural diagram in a bottom view of the first hob in the present invention;

### LABELS

1 first hob; 2 second hob; 3 rotation connecting mechanism; 4 first connecting part; 5 second connecting part; 6 power line; 7 first connecting groove; 8 second connecting groove; 101 first bottom housing; 102 first top housing; 103 first glass front panel; 104 first electromagnetic coil; 201 second bottom housing; 202 second top housing; 203 second glass front panel; 204 second electromagnetic coil; 301 connecting shaft; 302 rotating shaft; 303 connecting channel; 401 first avoidance opening; 501 second avoidance opening.

### DETAILED DESCRIPTION OF THE EMBODIMENTS

The technical solutions in the embodiments of the present disclosure are clearly and completely described below in conjunction with the accompanying drawings of the present disclosure, but without limiting the scope of the present disclosure.

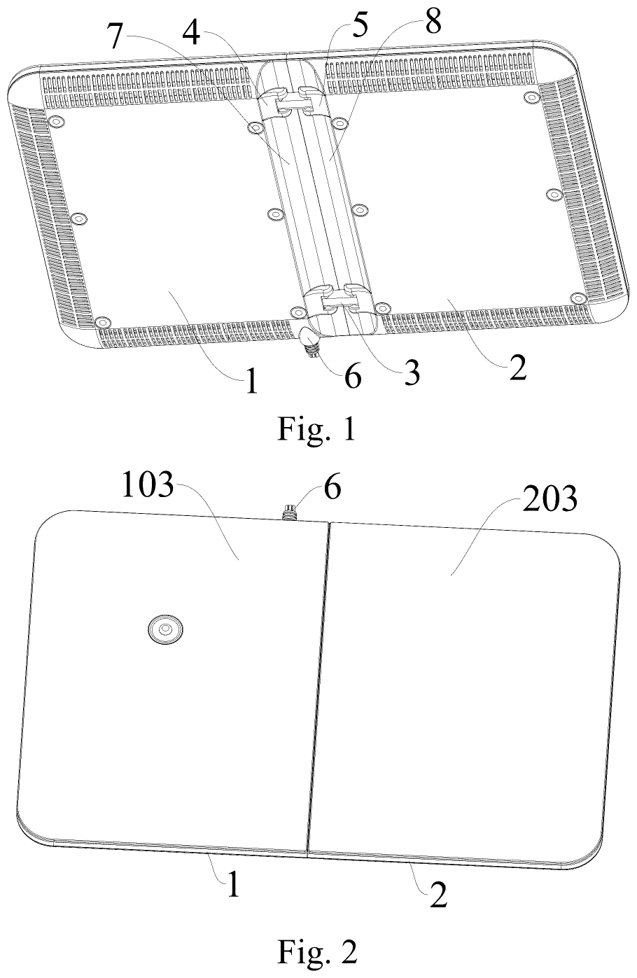

In the present disclosure, for better description, the following illustrations are made: the observer faces the accompanying FIG. 1 for observation, the left side of the observer is set to left, the right side of the observer is set to right, the front of the observer is set to upper, the back of the observer is set to lower, the upper of the observer is set to back, and the lower of the observer is set to front. It should be noted that the terms “front,” “back,” “left,” “right,” “center,” “top,” “bottom,” and the like are used in the text to indicate orientation or positional relationships based on the accompanying drawings only for the purpose of facilitating a clear description of the present disclosure and are not intended to indicate or imply that the structures or parts referred to necessarily have a particular orientation or are constructed in a particular orientation and, therefore, are not to be construed as a limitation of the present disclosure. In addition, the related terms “first”, “second”, “third” and “fourth”, if any, are used solely for purposes of clarity or simplicity of description and are not intended to indicate or imply relative importance or quantity.

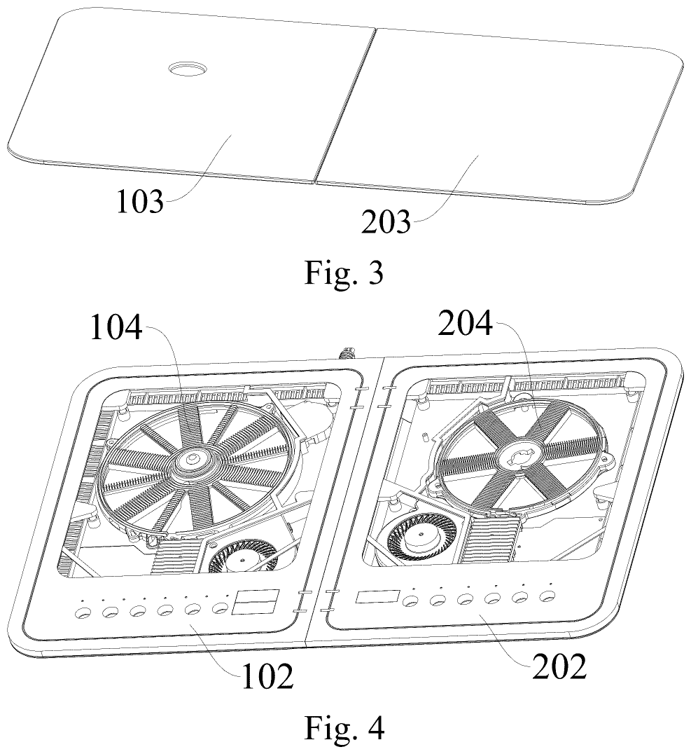

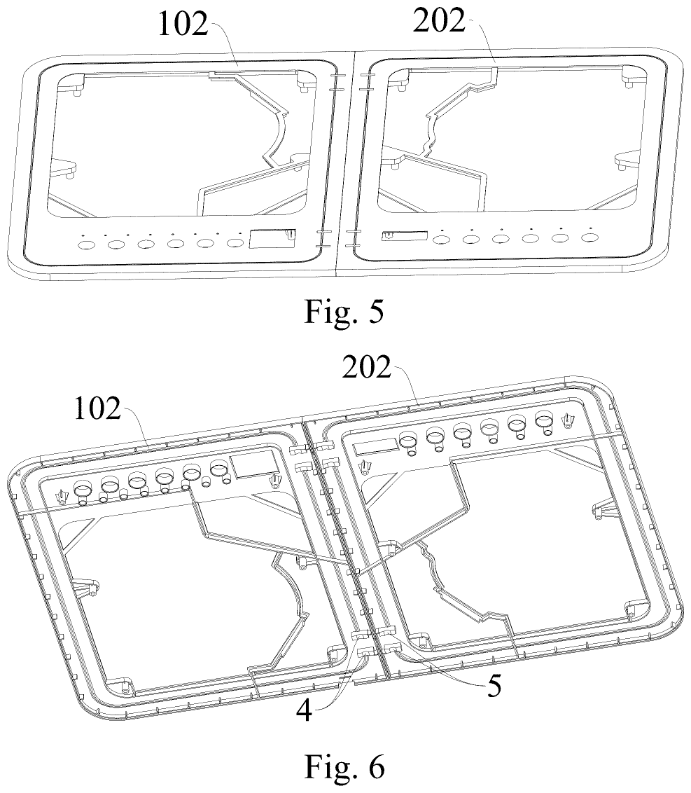

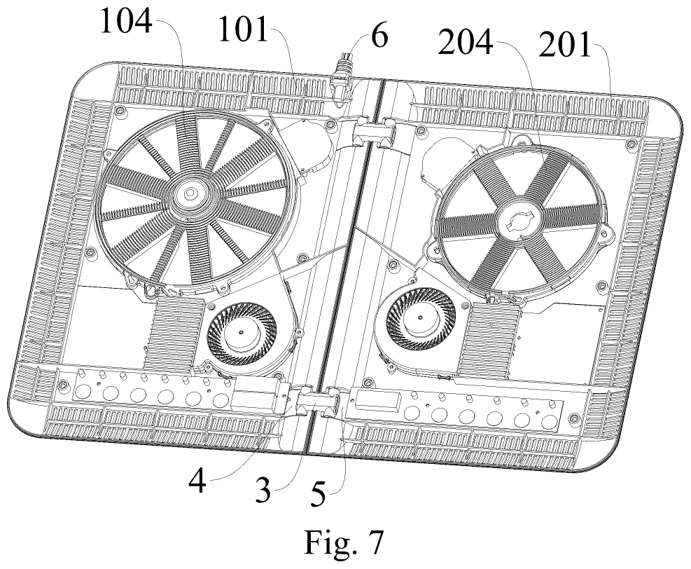

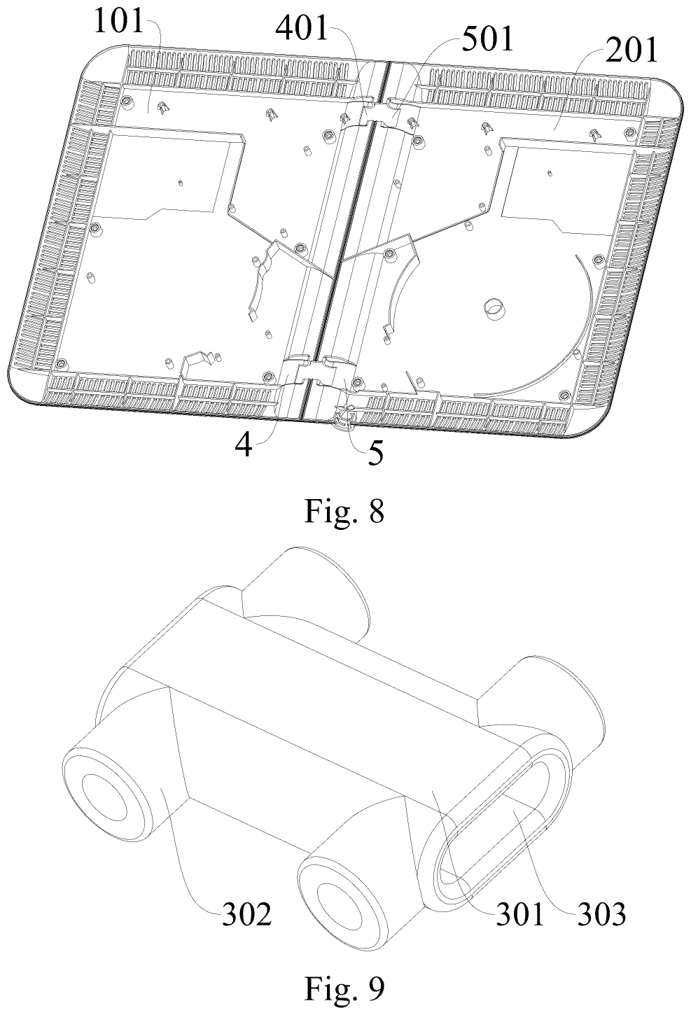

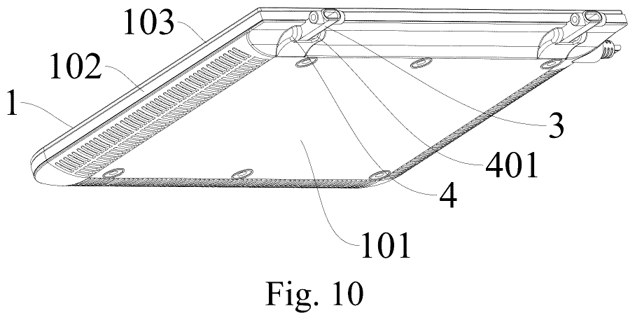

Referring to FIGS. 1-10, provided in the present embodiment is an induction hob for easy storage, including a first hob 1 and a second hob 2, in which the first hob 1 and the second hob 2 are configured with a first cooking position and a second cooking position respectively, the first cooking position and the second cooking position are capable of performing cooking simultaneously, a rotation connecting mechanism is provided between the first hob 1 and the second hob 2, the first cooking position and/or the second cooking position are/is able to rotate around the rotation connecting mechanism 3 until the a front panel of the first hob 1 is facing a front panel of the second hob 2 or a back panel of the first hob 1 is facing a back panel of the second hob 2.

In the present solution, by including the first hob 1 and the second hob 2, the first hob 1 and the second hob 2 are configured with the first cooking position and the second cooking position respectively, so that the first cooking position and the second cooking position may be cooked simultaneously, thereby allowing the present induction hob to achieve simultaneous cooking of two cookers to satisfy the user's cooking needs. Admittedly, the first cooking position and the second cooking position may be controlled by power on/off and may achieve separate operation as well. However, it should be noted that, regardless of whether the first cooking position and the second cooking position are operating simultaneously or only one of them is active, the first hob 1 and the second hob 2 are in an unfolded state, i.e., in the state shown in FIG. 2.

In the present solution, a rotation connecting mechanism 3 is also provided between the first hob 1 and the second hob 2, so that the first hob 1 and the second hob 2 are capable of being rotated around the rotation connecting mechanism 3, which allows the first hob 1 and the second hob 2 to be folded together. When it is desired to be stored after cooking, the first hob 1 may be rotated around the rotation connecting mechanism to the opposite position of the second hob 2, or the second hob 2 may be rotated around the rotation connecting mechanism to the opposite position of the first hob 1, so as to allow the first hob 1 and the second hob 2 to be folded together, which shortens the length of the induction hob and very convenient to be stored.

As shown in FIG. 2, the first hob 1 and the second hob 2 are arranged sequentially from left to right or from front to back. Generally, according to cooking habits, the first hob 1 and the second hob 2 are arranged sequentially from left to right. Admittedly, when cooking, the induction hob may be placed reasonably according to the on-site environment and space for cooking. At this moment, the first hob 1 and the second hob 2 may be close to the operator's left-hand side and right-hand side, or may be in a front and rear position along the direction of the operator's visualization, which is not limited to the allocation relationship of the first hob 1 and the second hob 2 herein.

Additionally, the first cooking position and the second cooking position configured on the first hob 1 and the second hob 2, respectively, may be provided side by side or in a zigzagged pattern with a certain distance apart, which increases the space around the first cooking position and the second cooking position to avoid crowding or interference problems when the first and second cooking positions are working at the same time.

In the above solution, the first hob 1 and/or the second hob 2 are/is rotated around the rotation connecting mechanism 3 until the a front panel of the first hob 1 is facing a front panel of the second hob 2 or a back panel of the first hob 1 is facing a back panel of the second hob 2, which means that the first hob 1 or the second hob 2 is rotated around the rotation connecting mechanism 3, or both the first hob 1 and the second hob 2 are rotated around the rotation connecting mechanism 3, and the state after completed rotation is a state in which the first hob 1 and the second hob 2 are folded relative to each other, substantially shortening the overall length of the induction hob. If a length of the first hob 1 is substantially equal to that of the second hob 2, after folding, the overall length of the induction hob is basically halved, which facilitates the packaging, transportation and storage of the induction hob.

As shown in FIG. 2 being the schematic perspective structural diagram in a top view of an embodiment of the induction hob for easy storage in the present disclosure, in the present embodiment, the first hob 1 and the second hob 2 of the induction hob are close to the left hand and the right hand of the operator respectively, which conforms to people's daily cooking habits.

As shown in FIG. 2, in the present embodiment, after the induction hob needs to be stored, it may be that the first hob 1 is rotated upwards and folded towards the front panel of the second hob 2;
or it may be that the first hob 1 is rotated backwards and folded towards the back panel of the second hob 2;
or it may be that the second hob 2 is rotated upwards and folded towards the front panel of the first hob 1;
or it may be that the second hob 2 is rotated backwards and folded towards the back panel of the first hob 1;
or it may be that both the first hob 1 and the rotation connecting mechanism 3 as a whole are rotated upwards or backwards and folded towards the front panel or back panel of the second hob 2;
or it may be that both the second hob 2 and the rotation connecting mechanism 3 as a whole are rotated upwards or backwards and folded towards the front panel or back panel of the first hob 1;
or it may be that both the first hob 1 and the second hob 2 are rotated around the rotation connecting mechanism 3, and both of them are rotated upwards or backwards; and
after the rotation is completed, all end up in a state where the front panel of the first hob 1 is facing the front panel of the second hob 2 or where the back panel of the first hob 1 is facing the back panel of the second hob 2.

Therefore, in the present solution, the induction hob is provided with the first hob 1, the second hob 2, and the rotation connecting mechanism 3, so that the first hob 1 and the second hob 2 are served as two hobs to satisfy the user's cooking needs, in which the first hob 1 and/or the second hob 2 may be rotated so as to allow the first hob 1 and the second hob 2 to be folded together, which shortens the length of the induction hob and very convenient to be stored. Accordingly, as the first hob 1 and the second hob 2 of the induction hob for easy storage may be folded together as well as opened side by side according to the user's needs, thereby not only increasing the cooking positions, but also facilitating the storage.

Specifically, the rotation connecting mechanism 3 includes a plurality of connecting shafts 301 arranged in parallel, both ends of the connecting shaft 301 are extended to the first hob 1 and the second hob 2 respectively, both ends of the connecting shaft 301 are connected to rotating shafts 302 arranged in parallel to each other respectively, an end of the rotating shaft 302 is fixedly connected to an outer peripheral wall of the connecting shaft 301, an opposite end of the rotating shaft 302 is extended outwardly in a radial direction of the connecting shaft 301, the first hob 1 and the second hob 2 are rotatably connected to the rotating shafts 302 on both ends of the connecting shaft 301 respectively, and the first hob 1 and the second hob 2 are rotated about the rotating shaft 302 proximal thereto respectively.

Based on the above solution, the rotation connecting mechanism 3 is of simple structure, the connecting shaft 301 provides conditions for the setup of the rotating shaft 302, and the rotating shaft 302 is fixedly provided at both ends of the connecting shaft 301 and is extended in the radial direction of the connecting shaft 301, which ensures that both the first hob 1 and the second hob 2 are connected to the same connecting shaft 301, allowing the first hob 1 and/or the second hob 2 to be rotated around the rotating shaft 302 proximal thereto, achieving the folding of the first hob 1 and the second hob 2.

Provided are a plurality of connecting shafts 301, which allows that there are a plurality of connecting positions between the first hob 1 and the second hob 2, ensuring that the connection between the first hob 1 and the second hob 2 is reliable, ensuring that the first hob 1 and the second hob 2 are kept relatively fixed and balanced after being unfolded or folded, improving the stability of the overall structure of the induction hob.

In the present solution, both ends of the connecting shaft 301 are provided with two rotating shafts 302 respectively, two rotating shafts 302 positioned on a same end of the connecting shaft 301 are provided coaxially and are both connected to the first hob 1 or the second hob 2. Both ends of the connecting shaft 301 are provided with two rotating shafts 302 respectively, and two rotating shafts 302 positioned on a same end of the connecting shaft 301 are provided coaxially, so that there are two connecting positions when the first hob 1 or the second hob 2 is connected to one connecting shaft 301, which ensures a relatively stable state of first hob 1 or the second hob 2 to the connecting shaft 301.

Referring to FIGS. 2 and 9, FIG. 2 is a schematic perspective structural diagram in a top view of an implementation of the induction hob for easy storage in the present disclosure. In the present embodiment, the first hob 1 and the second hob 2 of the induction hob are close to the left hand and the right hand of the operator respectively. In the present embodiment, referring to FIG. 9, the rotation connecting mechanism 3 includes a connecting shaft 301 extending to left and right sides. Both the left and right ends of the connecting shaft 301 are provided with rotating shafts 302 respectively, and an axial direction of the rotating shaft 302 is extended to front and back direction of the induction hob. The rotating shafts 302 on both left and right ends are rotatably connected to the first hob 1 and the second hob 2 respectively, which achieves that the first hob 1 and the second hob 2 are folded together or opened side by side.

In the present solution, at least one of the connecting shafts 301 is provided with a connecting channel 303 in communication with both ends of the connecting shaft 301, wires are threaded through the connecting channel 303, both ends of the wires are extended to the first hob 1 and the second hob 2 and power the first cooking position and the second cooking position, one of the first hob 1 and the second hob 2 is provided with a power line 6, the power line 6 is electrically connected to an end of the wires proximal thereto, and the connecting channel 303 wraps at least partially around the wire. This allows a single power line 6 to be provided to power both hobs collectively. The wires are threaded through the connecting channel 303, which facilitates the arrangement of the wires and also achieves the protection of the wires, avoiding that the wires are exposed between the first hob 1 and/or the second hob 2 after the first hob 1 and/or the second hob 2 are folded, which renders the wires susceptible to wear and tear or disconnection problems.

As shown in FIG. 9, an interior of the connecting shaft 301 is provided with a connecting channel 303 penetrating along the left and right, and the connecting channel 303 is penetrated within the connecting shaft 301, which facilitates complete wrapping of the wire and better protection of the wire.

Specifically, two connecting shafts 301 arranged along the front and back are connected between the first hob 1 and the second hob 2, one set of wires of the wires connected to the power line 6 passes through the connecting channel 303 of one of the connecting shafts 301, and another set of wires of the wires connected to the power line 6 passes through the connecting channel 303 of the other connecting shaft 301. Effect: By providing two connecting shafts 301, the connection between the first hob 1 and the second hob 2 and the stability when rotating are made better, and the forces applied thereto are more balanced. Additionally, the wire electrically connected to the power line 6 may lead to two sets of wires, one set of wires (including a live wire and a neutral wire) supplying power to the first hob 1, and the other set of wires (also including a live wire and a neutral wire) passing through the connecting channels 303 of the two connecting shafts 301 into the second hob 2, respectively, to supply power to the second hob 2. The risk of short-circuiting is reduced here by threading the neutral and live wires through separate connection channels 303.

In the present solution, the connecting shaft 301 is in a flat tubular shape, the connecting shaft 301 is provided with an upper surface, a lower surface, and two lateral surfaces in a height direction of the induction hob, and both the upper surface and the lower surface are planar and connected to both lateral surfaces in a smooth transition. Effect: The flat tubular connecting shaft 301 has a flat upper surface and lower surface, which makes it easier to be abutted the connecting shaft 301 against the bottom surfaces of the edges of the first hob 1 and the second hob 2, which improves the uniformity of the applied force, improves the stability of the first hob 1 and the second hob 2, especially the stability of the first hob 1 and the second hob 2 after they are unfolded, also effectively facilitates the reduction of the height of the connecting shaft 301, which is conducive to the reduction of the height of the first connecting part 4 and the second connecting part 5, and is conducive to the reduction of the overall height of the induction hob.

In the present solution, a side of the first hob 1 proximal to the second hob 2 is provided with a first connecting part 4, a side of the second hob 2 proximal to the first hob 1 is provided with a second connecting part 5, the first connecting part 4 is provided opposite to the second connecting part 5, a quantity of the first connecting part 4 and that of the second connecting part 5 corresponds to that of the connecting shafts 301 respectively. The rotating shafts 302 respectively positioned on both ends of the connecting shaft 301 are rotatably connected to the first connecting part 4 and the second connecting part 5 respectively, and the first connecting part 4 and the second connecting part 5 are rotated about the rotating shaft 302 proximal thereto.

The first connecting part 4 and the second connecting part 5 work together to provide positions for mounting the rotation connecting mechanism 3, the first connecting part 4 and the second connecting part 5 are fixedly provided to the first hob 1 and the second hob 2 respectively, and the first connecting part 4 and/or the second connecting part 5 are/is rotated around the rotation connecting mechanism 3, which achieves the rotation folding of the first hob 1 and/or the second hob 2.

In the present solution, the first connecting part 4 is provided with a first avoidance opening 401, the second connecting part 5 is provided with a second avoidance opening 501, and both ends of the connecting shaft 301 are placed into the first avoidance opening 401 and the second avoidance opening 501 respectively. The first avoidance opening 401 and the second avoidance opening 501 are arranged to provide space to accommodate both ends of the connecting shaft 301 respectively. For ensuring that both ends of the connecting shaft 301 do not interfere with the first connecting part 4 and the second connecting part 5 when the first hob 1 and the second hob 2 are rotated, the first avoidance opening 401 and the second avoidance opening 501 should be sufficiently large so that both ends of the connecting shaft 301 may be rotated within the first avoidance opening 401 and the second avoidance opening 501.

In the present solution, the first connecting part 4 is provided with a first connecting groove 7, the second connecting part 5 is provided with a second connecting groove 8, the rotating shafts 302 positioned on both ends of the connecting shaft 301 are placed into the first connecting groove 7 and the second connecting groove 8, and the first connecting groove 7 and the second connecting groove 8 are rotated about the rotating shaft 302 proximal thereto. The first connecting groove 7 and the second connecting groove 8 are used to accommodate the rotating shaft 302 and to ensure that the rotating shaft 302 is rotatable with respect to the first connecting groove 7 or the second connecting groove 8.

The first connecting part 4 and the second connecting part 5 are rotatably cooperated with the connecting shaft 301, respectively, and the connecting shaft 301 passes through the first avoidance opening 401 and the second avoidance opening 501 and is rotatable up and down. Effect: When the first hob 1 and the second hob 2 are rotated, the rotating shafts 302 at the left and right ends are rotated to cooperate with the first connecting part 4 and the second connecting part 5 respectively, and the connecting shafts 301 are rotated up and down in the first avoidance opening 401 and the second avoidance opening 501, so as to achieve that the first hob 1 and the second hob 2 are folded together or opened side-by-side.

Additionally, for facilitating that the first hob 1 and the second hob 2 are kept in a substantially parallel state after being folded, and ensuring that both the first hob 1 and the second hob 2 are rotated upward, i.e., the front panel of the first hob 1 is opposite to the front panel of the second hob 2 after being rotated, the first avoidance opening 401 and the second avoidance opening 501 are provided as openings toward the front panel of the induction hob, and are provided in a closed state toward the back panel of the induction hob. This ensures that both the first hob 1 and the second hob 2 are rotated upwards as shown in FIG. 2. After rotation, the front panel of the first hob 1 and the front panel of the second hob 2 are kept in a substantially parallel state, so as to avoid the front panel of the first hob 1 and the front panel of the second hob 2 from colliding with each other. In the present solution, the rotating shafts 302 at both ends of the connecting shaft 301 are provided so that both the first hob 1 and the second hob 2 are able to rotate, enabling the induction hob, which is in a folded state, to be shorter in length and more regular in size after rotation, facilitating packaging and storing.

For ensuring that the first hob 1 and the second hob 2 are kept in a flat unfolded state after opening, and that the first hob 1 and the second hob 2 are in a relatively fixed state, as shown in FIG. 2, when the first hob 1 and the second hob 2 are opened side-by-side, the upper edge of the first connecting groove 7 is abutted against the upper edge of the second connecting groove 8, so that the first hob 1 and the second hob 2 are restricted to a parallel state of left-right arrangement, and are in an up-down arrangement when folded, thereby allowing a 180° angle of rotation to be restricted.

In the present solution, the first connecting part 4 includes a first half block and a second half block opposite to each other, both the first half block and the second half block are provided in a height direction of the induction hob, both the first half block and the second half block are provided with first semi-circular grooves opposite to each other, radii of two first semi-circular grooves correspond to each other, and depths of two first semi-circular grooves correspond to each other. The first avoidance opening 401 is formed by opposite abutting of the first half block and the second half block, and the first connecting groove 7 is formed by opposite abutting of the two first semi-circular grooves.

The second connecting part 5 includes a third half block and a fourth half block provided opposite to each other, the third half block and the fourth half block are provided in a height direction of the induction hob, both the third half block and the fourth half block are provided with second semi-circular grooves opposite to each other, radii of two second semi-circular grooves correspond to each other, and depths of two second semi-circular grooves correspond to each other. The second avoidance opening 501 is formed by opposite abutting of the third half block and the fourth half block, and the second connecting groove 8 is formed by opposite abutting of the two second semi-circular grooves.

The arrangement of the first half block, the second half block, and two first semi-circular grooves, and the arrangement of the third half block, the fourth half block, and two second semi-circular grooves facilitate the assembly and disassembly of the connecting shaft 301 to the first connecting part 4 and the second connecting part 5.

Further, for facilitating the mounting of the connecting shaft 301, the rotating shaft 302, the first hob 1, and the second hob 2, in a height direction of the induction hob, the first hob 1 includes a first bottom housing 101, a first top housing 102, and a first glass front panel 103 provided sequentially from bottom to top, the second hob 2 includes a second bottom housing 201, a second top housing 202, and a second glass front panel 203 provided sequentially from bottom to top. The first bottom housing 101 is detachably connected to the first top housing 102, the first half block is fixed provided on the first bottom housing 101, the second half block is fixed provided on the first top housing 102, the first avoidance opening 401 and the first connecting groove 7 are formed by opposite abutting of the first bottom housing 101 and the first top housing 102, the second bottom housing 201 is detachably connected to the second top housing 202, the third half block is fixed provided on the second bottom housing 201, the fourth half block is fixed provided on the second top housing 202, and the second avoidance opening 501 and the second connecting groove 8 are formed by opposite abutting of the second bottom housing 201 and the second top housing 202.

When mounting the rotation connecting mechanism 3, the first bottom housing 101 and the second bottom housing 201 are first placed horizontally, then both ends of each connecting shaft 301 are placed onto the first half block and the third half block, it is ensured that both ends of the connecting shaft 301 are positioned within the first avoidance openings 401 and the second avoidance openings 501, respectively, and it is also ensured that the rotating shafts 302 at both ends of the connecting shaft 301 are positioned within the first connecting groove 7 or the second connecting groove 8, respectively. The first top housing 102 and the second top housing 202 are then snapped onto the first bottom housing 101 and the second bottom housing 201, respectively, ensuring that the second half block and the fourth half block are in close contact with the first half block and the third half block, respectively, to achieve the mounting of the rotation connecting mechanism 3.

A first electromagnetic coil 104 is provided between the first bottom housing 101 and the first top housing 102, the first cooking position is provided on the first glass front panel 103, the first electromagnetic coil 104 is positioned right below the first cooking position, a second electromagnetic coil 204 is provided between the second bottom housing 201 and the second top housing 202, the second cooking position is provided on the second glass front panel 203, and the second electromagnetic coil 204 is positioned right below the second cooking position. The first glass front panel 103 is formed as the front panel of the first hob 1, the first bottom housing 101 is formed as the back panel of the first hob 1, the second glass front panel 203 is formed as the front panel of the second hob 2, and the second bottom housing 201 is formed as the back panel of the second hob 2.

An alternating current may be introduced into the electromagnetic coil when in use, and an alternating magnetic field will be generated around the coil, and most of the magnetic lines of the alternating magnetic field pass through the pan, generating a large number of eddy currents in the bottom of the pan, thereby generating the heat required for cooking. Admittedly, there may be other required components for the induction hob, and the specific components may be selected on their own as required, which is not specifically limited herein.

In summary, the rotation connecting mechanism 3 of the present disclosure may not only achieve the folding of the first hob 1 and the second hob 2, but also may be used for the threading of wires between the first hob 1 and the second hob 2, and different types of induction hob may be selected for the first hob 1 and the second hob 2 according to the actual needs.

The above described is preferred embodiments of the present disclosure. It should be noted that for those skilled in the art, a plurality of improvements and modifications may be made without departing from the principles of the present disclosure, which should also be considered as the scope of protection of the present disclosure.

1. An induction hob for easy storage, comprising a first hob and a second hob, wherein the first hob and the second hob are configured with a first cooking position and a second cooking position respectively, the first cooking position and the second cooking position are capable of performing cooking simultaneously, a rotation connecting mechanism is provided between the first hob and the second hob, the first cooking position and/or the second cooking position are/is able to rotate around the rotation connecting mechanism until a front panel of the first hob is facing a front panel of the second hob or a back panel of the first hob is facing a back panel of the second hob.

2. The induction hob for easy storage according to claim 1, wherein the rotation connecting mechanism comprises a plurality of connecting shafts arranged in parallel, both ends of the connecting shaft are extended to the first hob and the second hob respectively, both ends of the connecting shaft are connected to rotating shafts arranged in parallel to each other respectively, an end of the rotating shaft is fixedly connected to an outer peripheral wall of the connecting shaft, an opposite end of the rotating shaft is extended outwardly in a radial direction of the connecting shaft, the first hob and the second hob are rotatably connected to the rotating shafts on both ends of the connecting shaft respectively, and the first hob and the second hob are rotated about the rotating shaft proximal thereto respectively.

3. The induction hob for easy storage according to claim 2, wherein both ends of the connecting shaft are provided with two rotating shafts respectively, two rotating shafts positioned on a same end of the connecting shaft are provided coaxially and are both connected to the first hob or the second hob.

4. The induction hob for easy storage according to claim 2, wherein at least one of the connecting shafts is provided with a connecting channel in communication with both ends of the connecting shaft, wires are threaded through the connecting channel, both ends of the wires are extended to the first hob and the second hob and power the first cooking position and the second cooking position, one of the first hob and the second hob is provided with a power line, the power line is electrically connected to an end of the wires proximal thereto, and the connecting channel wraps at least partially around the wires.

5. The induction hob for easy storage according to claim 2, wherein the connecting shaft is in a flat tubular shape, the connecting shaft is provided with an upper surface, a lower surface, and two lateral surfaces in a height direction of the induction hob, and both the upper surface and the lower surface are planar and connected to both lateral surfaces in a smooth transition.

6. The induction hob for easy storage according to claim 2, wherein a side of the first hob proximal to the second hob is provided with a first connecting part, a side of the second hob proximal to the first hob is provided with a second connecting part, the first connecting part is provided opposite to the second connecting part, a quantity of the first connecting part and that of the second connecting part corresponds to that of the connecting shafts respectively,
the rotating shafts respectively positioned on both ends of the connecting shaft are rotatably connected to the first connecting part and the second connecting part respectively, and the first connecting part and the second connecting part are rotated about the rotating shaft proximal thereto.

7. The induction hob for easy storage according to claim 6, wherein the first connecting part is provided with a first avoidance opening, the second connecting part is provided with a second avoidance opening, both ends of the connecting shaft are placed into the first avoidance opening and the second avoidance opening respectively,
the first connecting part is provided with a first connecting groove, the second connecting part is provided with a second connecting groove, the rotating shafts positioned on both ends of the connecting shaft are placed into the first connecting groove and the second connecting groove, and the first connecting groove and the second connecting groove are rotated about the rotating shaft proximal thereto.

8. The induction hob for easy storage according to claim 7, wherein the first connecting part comprises a first half block and a second half block opposite to each other, both the first half block and the second half block are provided in a height direction of the induction hob, both the first half block and the second half block are provided with first semi-circular grooves opposite to each other, radii of two first semi-circular grooves correspond to each other, and depths of two first semi-circular grooves correspond to each other;
the first avoidance opening is formed by opposite abutting of the first half block and the second half block, and the first connecting groove is formed by opposite abutting of the two first semi-circular grooves;
the second connecting part comprises a third half block and a fourth half block provided opposite to each other, the third half block and the fourth half block are provided in a height direction of the induction hob, both the third half block and the fourth half block are provided with second semi-circular grooves opposite to each other, radii of two second semi-circular grooves correspond to each other, and depths of two second semi-circular grooves correspond to each other; and
the second avoidance opening is formed by opposite abutting of the third half block and the fourth half block, and the second connecting groove is formed by opposite abutting of the two second semi-circular grooves.

9. The induction hob for easy storage according to claim 8, wherein in a height direction of the induction hob, the first hob comprises a first bottom housing, a first top housing, and a first glass front panel provided sequentially from bottom to top, a first electromagnetic coil is provided between the first bottom housing and the first top housing, the first cooking position is provided on the first glass front panel, the first electromagnetic coil is positioned right below the first cooking position, the second hob comprises a second bottom housing, a second top housing, and a second glass front panel provided sequentially from bottom to top, a second electromagnetic coil is provided between the second bottom housing and the second top housing, the second cooking position is provided on the second glass front panel, and the second electromagnetic coil is positioned right below the second cooking position; and
the first glass front panel is formed as the front panel of the first hob, the first bottom housing is formed as the back panel of the first hob, the second glass front panel is formed as the front panel of the second hob, and the second bottom housing is formed as the back panel of the second hob.

10. The induction hob for easy storage according to claim 9, wherein the first bottom housing is detachably connected to the first top housing, the first half block is fixed provided on the first bottom housing, the second half block is fixed provided on the first top housing, the first avoidance opening and the first connecting groove are formed by opposite abutting of the first bottom housing and the first top housing, the second bottom housing is detachably connected to the second top housing, the third half block is fixed provided on the second bottom housing, the fourth half block is fixed provided on the second top housing, and the second avoidance opening and the second connecting groove are formed by opposite abutting of the second bottom housing and the second top housing.
